(19) United States
(12) Patent Application Publication
(10) Pub. No.: US 2010/0003116 A1
(43) Pub. Date: Jan. 7, 2010

(54) Transport vehicle for raising and transporting ULDs and cargo pallets

(76) Inventor: Matthias Klein, Hanau (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/498,445

(22) Filed: Jul. 7, 2009

(30) Foreign Application Priority Data
Jul. 7, 2008 (DE) 10 2008 031 981.3

(51) Int. Cl. B60P 1/32

(52) U.S. Cl. 414/478; 414/812

(57) ABSTRACT

A transport vehicle is provided for raising and transporting ULDs and cargo pallets used in the air freight sphere, with a supporting frame which fits over the ULD or the cargo pallet and with driven and steerable wheels for the free movement of the transport vehicle on the ground. In order to simplify the complicated reloading of transport units onto auxiliary pallets, it is proposed according to the invention that the transport vehicle is movable over the ULD or the cargo pallet at least in one direction, that supporting devices arranged on both sides of the frame of the transport vehicle are movable at the same time in the opposite direction under the ULD or the cargo pallet, and that, in the process, the ULD or the cargo pallet is raisable with the aid of the supporting devices.

### CROSS REFERENCE TO RELATED APPLICATIONS

This application claims priority of German application No. 10 2008 031 981.3 DE filed Jul. 7, 2008, which is incorporated by reference herein in its entirety.

### FIELD OF INVENTION

The invention relates to a transport vehicle for raising and transporting ULDs and cargo pallets used in the air freight sphere, with a supporting frame which fits over the ULD or the cargo pallet, said transport vehicle comprising at least lower longitudinal struts and upper longitudinal and transverse struts, and also vertical supporting struts connecting the lower and upper struts, and with driven and steerable wheels for the free movement of the transport vehicle on the ground.

### BACKGROUND OF INVENTION

The cargo pallets and unit load containers used in the air freight sphere and referred to in technical jargon as ULDs have to satisfy particular requirements. The ULDs and cargo pallets, including the firmly secured load arranged thereon, must not exceed certain dimensions and weights. Therefore, the ULDs and the cargo pallets are frequently composed of high-strength aluminum which, if appropriate, is reinforced in order to avoid impermissible bowing. In order to handle the cargo pallets, use is frequently made of auxiliary pallets (slave pallets) which serve to correspondingly support the cargo pallets.

For the transport of loaded and empty auxiliary pallets, lifting vehicles which are constructed in a manner similar to a forklift truck and have a picking-up device projecting to an appropriate length on their front side, are known. In the vicinity of the free front end, the picking-up device has running wheels, the diameter of which is relatively small in order, in the lowered position, to be able to run under the auxiliary pallets which only have a small ground clearance in the picking-up region. The distance of the upper side of the picking-up device of the lifting vehicle in the lowered position from the traveling plane has to be correspondingly small.

The picking-up device of the known lifting vehicles is only slightly raised above the traveling plane such that the lift of the picking-up device is precisely enough to be able to lift the auxiliary pallet from the standing or traveling plane.

DE 20 2004 020 224 U1 has disclosed a lifting vehicle of the type mentioned at the beginning, in which the auxiliary pallet which is to be raised and transported is no longer underrun, but rather is grasped at mutually opposite sides in order to be able to lift or lower said auxiliary pallet. The lifting vehicle is therefore designed such that it is approximately C-shaped or U-shaped and fits around three sides of the rectangular pallet to be picked up. For this purpose, mutually opposite lifting bars can be lowered onto the carriageway plane. Although, with the known appliance, the auxiliary pallets can be raised as far as the loading level of a conventional truck and, because of the good maneuverability of the lifting vehicle, the pallets can easily be transported and stacked over the lifting height, the cargo pallets nevertheless have to be placed onto auxiliary pallets and removed again therefrom.

Other transport systems use “push-off pallets” which have, on their upper side, rolling bodies which are arranged in a protruding manner and form a conveying plane lying above the picking-up level of the auxiliary pallet. A cargo pallet previously supported by the auxiliary pallet is supported by the rolling bodies of the push-off pallet and can be pushed off from the auxiliary pallet and transferred to another conveying system, such as a roller conveyor. In the reverse conveying direction, an empty auxiliary pallet which is placed onto the push-off pallet can be loaded in an analogous manner with a cargo pallet which then, after being lifted off the push-off pallet, is maneuvered together with the auxiliary pallet.

It follows from the foregoing that, during the customary cargo forwarding operation, a plurality of push-off pallets and, in relation thereto, a plurality or multiplicity of auxiliary pallets are generally required in order to be able to solve the cargo pallet transport and handling problems which occur. Lifting appliances serve to transport, raise, lower or otherwise handle the loaded or empty auxiliary pallet, if appropriate together with the push-off pallet. The lifting platforms of the lifting appliances can be brought to a height such that the roller conveyor is aligned with a non-driven roller conveyor provided on a pallet. The roller conveyor of the lifting platform pushes the transport unit onto the non-driven roller conveyor. From there, the transport units are picked up by an appliance which is referred to as a donkey or a slave pallet mover. The donkey grasps the base of the slave pallet and brings it together with the item being transported, which is located on said pallet, for example to a pair of scales for weighing. The donkey subsequently moves the item being transported to a transport carriage which is provided with non-driven roller conveyors and is referred to as a “dolly”. The donkey transfers the transport unit onto the dollies which can be coupled together and towed by a driven moving tractor. In the region of the aircraft to be loaded, a drivable and steerable appliance, which is referred to as a mover and is provided with driven roller conveyors, takes over the item being transported from the dollies and moves it to the aircraft. A movable and steerable, height-adjustable loading platform which is provided with driven roller conveyors and is referred to as a “high loader” is provided there, said loading platform taking over the transport units and pushing them into the loading hatch of the aircraft.

### SUMMARY OF INVENTION

It follows from the foregoing that the transport and transfer operations are extensive and complicated, since they have to be carried out with the various reloading appliances described. This is laborious and time-consuming and disadvantageous in terms of economy of operation. It would be of advantage if individual reloading operations could be spared.

It is the object of the present invention, starting from the described prior art and the disadvantages thereof, to design a transport vehicle for ULDs and cargo pallets in the air freight sphere in such a manner that the complicated reloading of the transport units onto auxiliary pallets can be dispensed with by means being provided in order to pick up the ULDs and cargo pallets directly from the ground and further handle them.

To achieve the object, it is proposed according to the invention that the transport vehicle is movable over the ULD or the cargo pallet at least in one direction, that supporting devices arranged on both sides of the frame of the transport vehicle are movable at the same time in the opposite direction under the ULD or the cargo pallet, and that, in the process, the ULD or the cargo pallet is raisable with the aid of the supporting units. The ULD or the cargo pallet, lying on the ground, is reached under by the supporting devices and at the same time raised. This solution means that auxiliary pallets (slave pallets) no longer have to be used and, on the contrary, the cargo pallets or ULDs can be picked up directly from the ground and raised.

The supporting devices are of wedge-shaped design and have wedge tips directed in the direction of the ULD or cargo pallet. The wedge tips make it possible to reach under the ULD or the cargo pallet even in the event of a low ground clearance if said supporting devices, as provided by another feature of the invention, are movable with the wedge tips in front into the gap between the ground and the lower side of the ULD or the cargo pallet, which gap is caused by the constructional shape of the ULDs or cargo pallet. In the process, the surfaces of the wedge-shaped supporting devices, as the latter penetrate the gap, raise the ULD or the pallet.

In order to make it easier for the supporting device to penetrate the gap between the ground and lower side of the ULDs or cargo pallet, it is provided, according to a further proposal of the invention, that that surface of the wedge-shaped supporting device which faces the lower side of the ULD or the cargo pallet is provided with transport rollers or rolls which are mounted rotatably transversely with respect to the direction of movement of the supporting device and of which at least individual ones are drivable. Said transport rollers or rolls make it easier for the wedge-shaped supporting device to penetrate the gap under the ULD or cargo pallet and facilitate the raising thereof in relation to the ground.

It is furthermore made easier for the supporting device to penetrate the gap by the proposal according to the invention to provide the supporting devices also on the bottom side with running rollers, of which at least individual ones are drivable. The running rollers reduce the ground friction of the supporting device and make it easier for the supporting device to penetrate the gap under the ULD or the cargo pallet.

The supporting device is attached to the edge of the pallet and moved under the loading unit by the driven rollers which act both on the ground and on the lower edge of the pallet. In this connection, the bowing of the pallet to be observed as per the IATA is not exceeded.

In order to reduce the transport dimensions of the transport vehicle, it is provided, according to a further favorable feature of the invention, that the supporting devices are pivotable from a substantially vertically oriented rest position into a horizontally oriented operative position in which the supporting devices rest with their lower sides or running rollers on the ground, and that drives are provided in order to move the supporting devices under the lower side of the ULD or the cargo pallet. The supporting devices are therefore pivoted from a space-saving vertical rest position into the use position, preferably on a curved pivoting path, in order to push them substantially rectilinearly into the gap under the ULD or the cargo pallet.

The cargo pallet, under which the supporting devices reach in the operative position, is raised in a customary manner by further raising of the supporting devices on the frame of the transport vehicle.

A transport vehicle designed according to the invention no longer requires any auxiliary pallets for the handling of the cargo pallet. In addition, the construction can be used to provide substantially larger running wheels on the transport vehicle such that transport is possible even on uneven terrain. The drive of the supporting devices can be realized in various ways. Use can thus be made both of hydraulic and mechanical drives. The sole prerequisite for carrying out the invention is that the cargo pallet or the ULD has a small sufficient ground clearance in order to introduce the wedge-shaped supporting device into the gap between the ground and ULD or cargo pallet. This gap is ensured by the constructional shape of the loading unit prescribed as per the IATA.

### BRIEF DESCRIPTION OF THE DRAWINGS

An exemplary embodiment of the invention is illustrated in the drawing and described below. In the drawing:

FIG. 1 shows a transport vehicle according to the invention in a schematic, three-dimensional illustration,

FIG. 2 shows an enlarged illustration of the wedge-shaped supporting device,

FIG. 3 shows, in side view, the transport vehicle with the supporting devices in the rest position,

FIG. 4 shows the supporting devices pivoted in the direction of the operative position, and

FIG. 5 shows the supporting devices in the pivoted starting position from which they are conveyed under the ULD or the cargo pallet.

### DETAILED DESCRIPTION OF INVENTION

The transport vehicle 1 according to the invention which comprises the longitudinal struts 1a to 1f and the transverse struts 2a to 2c can be seen in the roughly schematic drawing. In the lower region of the transport vehicle, only two opposite, mutually parallel longitudinal struts 1e and 1f are provided and transverse struts are not present at this point. By means of the vertical supporting struts 7a to 7d which connect the longitudinal and transverse struts to one another to form a vehicle frame, it is possible to move the transport vehicle 1 over a ULD 4 or a cargo pallet 5 in the arrow direction 3 and, from this position, by lowering and pivoting the supporting devices 6, which are denoted by 6a and 6b, to reach under the ULD or the cargo pallet 5. Steerable wheels 8 are arranged at the lower ends of the supporting struts 7, said wheels being sufficiently dimensioned in diameter in order to also be able to move over uneven ground.

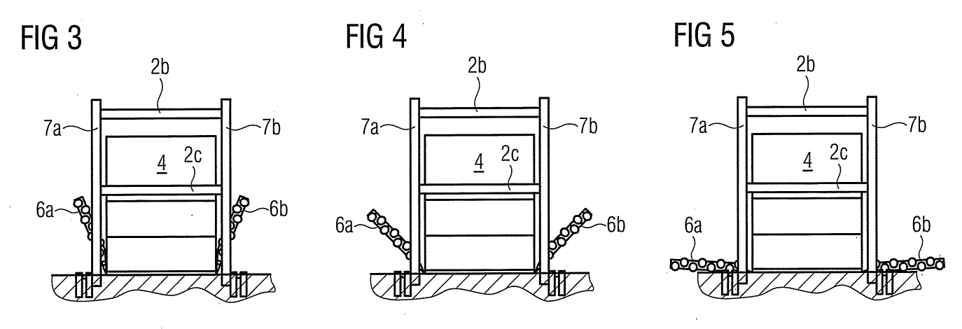

The operation to pick up a ULD is illustrated in roughly schematic form in FIGS. 3-5. It can also be seen from these figures that the supporting devices 6 comprise two wedge-shaped plates which are fastened on opposite sides of the longitudinal struts 1e and 1f of the frame and the wedge tip of which is oriented in the direction of the ULD 4 or the cargo pallet 5.

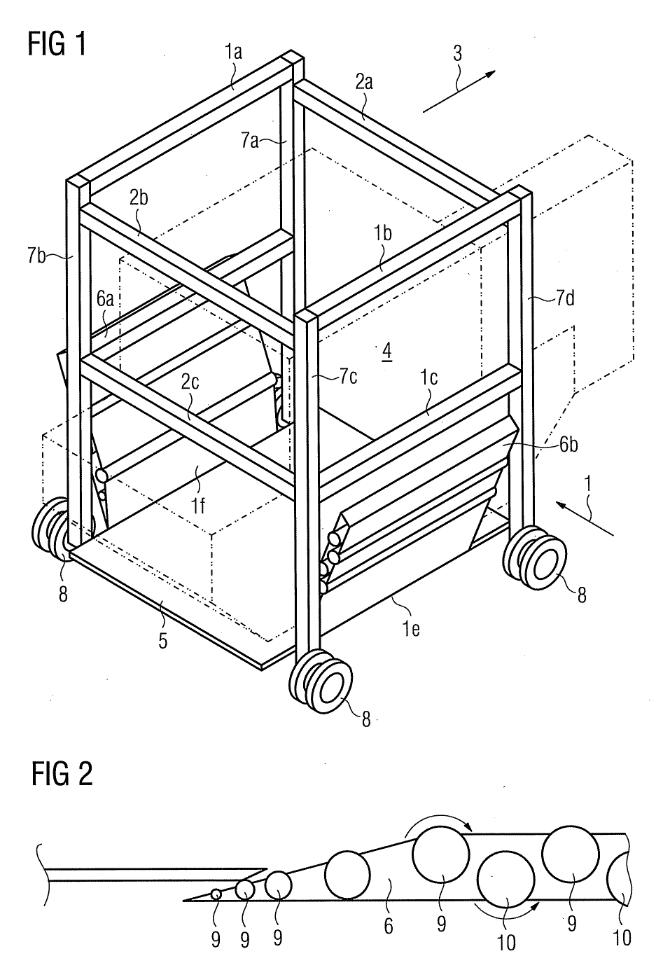

FIG. 2 shows an enlarged illustration of one of these supporting devices 6a or 6b. It is schematically shown in the figure of the drawing that the supporting device is equipped with supporting rollers or rolls 9 which make it easier for the wedge-shaped supporting device 6 to penetrate the gap between the ULD or the cargo pallet 4, 5 and the ground. The supporting rollers or rolls 9 are rotatable about horizontal axes and in the direction of movement of the supporting devices 6 and project with their surfaces over the surface plane of the supporting device 6. The rotatable supporting rollers or rolls 9 make it easier to run under the ULD or the cargo pallet 4, 5. The supporting rollers or rolls 9 which are arranged in the region of the wedge-shaped tip of the supporting device 6 have a smaller diameter than the other supporting rollers or rolls 9 so that, together with the supporting device 6, they can penetrate the defined gap below the cargo pallet or the ULD 4, 5.

It can also be seen in FIG. 2 that at least one running roller 10 is provided on the lower side of the supporting device, said running roller, which runs along the ground, likewise making it easier for the supporting device 6 to penetrate the gap, even if very high weights have to be handled.

As can be seen in FIG. 3, the supporting devices 6 are oriented substantially vertically in the transport position of the vehicle 1 and can be pivoted (FIG. 4) in such a manner that they can be brought into the operative position (FIG. 5), from which the two supporting devices 6a and 6b are moved toward each other under the ULD or the cargo pallet 4, 5. The two supporting devices 6a, 6b reach under the ULD or the cargo pallet 4, 5 and permit the raising thereof from the ground. By further simultaneous raising of the supporting devices 6 on both sides of the supporting frame, the ULD or the cargo pallet 4, 5 can be raised to the required height in order to be transferred to other supporting devices 6.

The drives for the supporting devices 6 are not illustrated, but are customary for a person skilled in the art in the form of hydraulic and/or mechanical drives.

1.-6. (canceled)

7. A transport vehicle that raises and transports a cargo carrier used in an air freight, comprising:
a supporting frame which fits over the cargo carrier, the supporting frame comprising:
lower longitudinal struts,
upper longitudinal struts,
transverse struts, and
vertical supporting struts connecting to the lower and upper longitudinal struts and to the traverse struts;
a plurality of steerable wheels providing free movement of the transport vehicle on the ground and such that the transport vehicle is movable over the cargo carrier;
a first supporting device arranged on a first side of the frame and movable in a first direction; and
a second supporting device arranged on a second side of the frame, which is opposite from the first side of the frame, and movable in a second direction, such that the first and second supporting devices are movable in tandem in the opposite direction under the cargo carrier, which is arranged under the transport vehicle, thereby raising the cargo carrier via the first and second supporting devices,
wherein the cargo carrier is a cargo pallet or a unit load device.

8. The transport vehicle as claimed in claim 7, wherein the first and second supporting devices each are wedge shaped including a wedge tip.

9. The transport vehicle as claimed in claim 8,
wherein the first and second supporting devices are movable such that each wedge tip is pointed in the direction of a gap between the ground and a lower side of the cargo carrier, and
wherein as the first and second supporting devices are moved in the first and second directions the wedge tips penetrate into the gap and the cargo carrier is raised onto the first and second supporting devices.

10. The transport vehicle as claimed in claim 8,
wherein the first and second supporting devices each include a plurality of transport rollers on the surface which faces the lower side of the cargo carrier, and
wherein each of the plurality of transport rollers are mounted rotatably transversely with respect to the direction of movement of the respective supporting device, and
wherein at least one of the plurality of transport rollers is driven.

11. The transport vehicle as claimed in claim 9,
wherein the first and second supporting devices each include a plurality of transport rollers on the surface which faces the lower side of the cargo carrier, and
wherein each of the plurality of transport rollers are mounted rotatably transversely with respect to the direction of movement of the respective supporting device.

12. The transport vehicle as claimed in claim 11, wherein at least one of the plurality of transport rollers is driven.

13. The transport vehicle as claimed in claim 8,
wherein the first and second supporting devices each include a plurality of running rollers on a bottom side of the respective supporting device, and
wherein at least one of the plurality of running rollers is driven.

14. The transport vehicle as claimed in claim 11,
wherein the first and second supporting devices each include a plurality of running rollers on a bottom side of the respective supporting device.

15. The transport vehicle as claimed in claim 14, wherein at least one of the plurality of running rollers is driven.

16. The transport vehicle as claimed in claim 7, further comprising
a plurality of drives,
wherein the first and second supporting devices each include a bottom side and each are pivotable from a substantially vertically oriented rest position into a horizontally oriented operative position in which the first and second supporting devices rest with the bottom side on the ground, and
wherein the plurality of drives move the first and second supporting devices under the lower side of the cargo carrier.

17. The transport vehicle as claimed in claim 14, further comprising
a plurality of drives,
wherein the first and second supporting devices each are pivotable from a substantially vertically oriented rest position into a horizontally oriented operative position in which the first and second supporting devices rest with the plurality of running rollers on the ground, and
wherein the plurality of drives move the first and second supporting devices under the lower side of the cargo carrier.

18. A method for transporting a cargo carrier used in an air freight, comprising:
providing a first supporting device arranged on a first side of the frame and movable in a first direction;
providing a second supporting device arranged on a second side of the frame, which is opposite from the first side of the frame, and movable in a second direction
moving a supporting frame of a transport vehicle over the cargo carrier such that the first supporting device is one side of the cargo carrier and the second supporting frame is on an opposite side of the cargo carrier; and
moving the first and second supporting devices towards each other thereby raising the cargo carrier which is under the supporting frame,
wherein the cargo carrier is a cargo pallet or a unit load device.

19. The method as claimed in claim 18, further comprising:
pivoting the first and second supporting devices from a vertically oriented rest position into a horizontally oriented operative position after the supporting frame is moved over the cargo carrier.
